(19) United States
(12) Patent Application Publication
(10) Pub. No.: US 2020/0029272 A1
(43) Pub. Date: Jan. 23, 2020

(54) METHOD FOR GEOGRAPHIC-BASED RADIOFREQUENCY BAND SELECTION

(71) Applicant: TRAXENS, MARSEILLE (FR)

(72) Inventors: Natale GUZZO, MARSEILLE (FR); Pascal DARAGON, GREAQUE (FR); Michel FALLAH, AUBAGNE (FR); Hanane BECHA, AIX EN PROVENCE (FR)

(21) Appl. No.: 16/469,309

(22) PCT Filed: Dec. 13, 2017
(86) PCT No.: PCT/EP2017/082717

§ 371 Date: Jun. 13, 2019

(30) Foreign Application Priority Data
Dec. 13, 2016 (EP) 16203862.4

(51) Int. Cl. H04W 48/16; H04W 48/18; H04W 72/04; H04W 4/021

(52) U.S. Cl. CPC H04W 48/16; H04W 48/18; G06Q 10/0833; H04W 4/021; H04W 72/0453

(57) ABSTRACT

The invention provides a method for data communication of a mobile device on a local area network, having a mobile device communication system, on an authorized radiofrequency band. The method comprising a step of determining a data communication mode being performed using a piece of geographical localization information obtained from a mobile communication network or a satellite-based positioning system; or a data communication mode obtained from a data frame exchange on said local area network. If no of this information is available the mobile device enters a silent state.

### TECHNICAL FIELD OF THE INVENTION

This invention relates to the field of selection or allocation of wireless resources. More specifically, this invention deals with methods for wireless tracking of assets. More particularly, the present invention relates to optimizing battery life and network resources during position tracking by automatic geographic-based frequency band selection.

### BACKGROUND

Numerous physical devices or items comprising sensors and, network connectivity are capable of collecting and sharing information about their own conditions and their surroundings. They may also autonomously adapt their behavior to the context. In addition to being context-aware, these items empower their end-users to change their status remotely using different communication protocols and technologies.

An example of network connectivity is, for instance, the international application WO2016005675 which is about a joining method, the international application WO2016151259 which describes a communication method within a network of wireless communicating electronic devices making it possible to dynamically and automatically control the propagation of enrolment messages or the international application WO2016083745 which discloses a method implemented by a communicating electronic device acting as a free node and can request a procedure for affiliation with a second device.

Connectivity is a prerequisite for tracking and monitoring solutions. The Item tracking and monitoring solution should provide interconnectivity between items and enable the tracking device to communicate, in a very energy efficient manner, with the terminal server anytime and anywhere, with a limited the cost.

Cellular networks and satellite communication technologies offer many advantages such as scalability and a global reach. However, such technologies require a significant electrical power and are costly. Therefore, they should be used as complementary communication solutions to the radio communication solution that mutualizes the energy usage when there is a cluster of devices and offer a better coverage for devices that have no line of sight.

Indeed, unlike automotive and other machine-to-machine devices, the smart containers are extremely energy constrained by nature. Dry containers do not have any power source and Reefer containers are not permanently powered on. Once the mobile device leaves the factory, it may be almost impossible to change or to charge the battery of the mobile device. The mobile device may be associated with a container and this container may be deployed globally and may move worldwide, e.g. crossing borders, in an unpredictable fashion. From there on, it may be out of reach without any physical access that permits maintenance or repairing.

Moreover, container selection and usage may be completely random. In some case, containers may be arranged in stacks or, on cargo vessels, stowed underdeck. Therefore, a tracking device located on a container may not be able to communicate via cellular technologies signal may be too weak. In such case, the mobile device may rapidly discharge its battery while trying to communicate and reduce its lifetime.

In addition, the terminal server may not be able to leverage mobile devices and enable customers to customize the behavior of mobile devices and define notification rules to forward information. Terminal servers may also not be able to leverages mobile devices computing power by sending them journey specific control rules such as detecting unexpected sensor values or unexpected events.

This invention relates to a solution to the previous problems by grouping a series of strategies to automatically select the frequency band to use in the communication between mobile devices. The proper frequency band is selected according to the current geographic position of the communicating device and the Short Radio Devices regulations in force in the traversed country.

### SUMMARY OF THE INVENTION

In order to achieve this objective, the present invention provides a method for data communication of a mobile device on a local area network, having a mobile device communication system, on an authorized radiofrequency band; the method comprising the following steps:
determining a current data communication mode, said current data communication mode defining at least a radiofrequency band for communicating data; said determination of said data communication mode being performed using:
   a) a piece of geographical localization information obtained from a mobile communication network or a satellite-based positioning system; or
   b) a data communication mode obtained from a data frame exchange on said local area network;
if the determination step is successful:
enabling a data communication state of the mobile device wherein use of a radiofrequency band defined on the basis of said current data communication mode for data communication between the mobile device and the local area network is allowed; or,
if the determination step is not successful such that no valid data communication mode can be determined:
entering a silent state; and
entering a sniffer mode.

According to an embodiment, the current data communication mode is associated with a validity time period and the method comprises a step of verifying a validity of the current data communication mode based on a current time and the validity period, and entering a silent state and or a determination step if the result of the verification step is not successful.

According to an embodiment, the method comprises a step of receiving the validity time period for the current data communication mode in network messages from a current leader node of the local area network.

According to an embodiment, the method comprises a step of updating the validity time of the current data communication mode according to the information transmitted by the current leader node in the local area network.

According to an embodiment, the method comprises a step of immediately enabling the new data communication mode communicated by the current leader node of the local area network.

Said behavior corresponds to a request to perform a “hard switching” of the data communication mode.

According to an embodiment, the sniffer mode corresponds to a step of listening to at least one dedicated channel for the reception of at least one network message comprising a current data communication mode and/or a next communication mode.

According to one aspect of the invention, said listening step can be construed as a sniffer mode. According to one aspect of the invention, the listening step may be active when the device is in the silent mode.

According to an embodiment, the method comprises a step of receiving at least one dedicated network message comprising a current data communication mode and/or a next communication mode.

According to one aspect of the invention, said at least one dedicated network message is sent in broadcast mode by a leader node of the local area network.

According to one aspect of the invention, the at least one dedicated network message can be defined as a Network Data Communication Mode Message.

According to an embodiment, the at least one message comprises a validity time period associated with the current communication mode.

According to an embodiment, the step of determination of said data communication mode being performed using a piece of geographical localization information is performed using a repository defining values of data communication modes corresponding to geographical areas.

According to an aspect of the invention, the method comprises a step of determination of the geographical area by converting the piece of geographical localization information obtained from the mobile communication network or the satellite-based positioning system into geographical area information. In particular, the step of determination of the geographical area comprises a step of compression of the geographical localization information obtained from the satellite-based positioning system by suppressing redundant piece of geographical localization information.

According to an aspect of the invention, the piece of geographical localization information comprises the current geographical localization information.

According to an aspect of the invention, the piece of geographical localization information comprises the next geographical localization information; the next geographical localization information is obtained by extrapolation of the geographical localization.

According to an embodiment, the method comprises a step of communicating to at least one node on the local area network a current or next data communication mode in at least one network message.

According to an aspect of the invention, said communication step may be performed if the mobile device is a current leader node of a cluster of devices on the local area network.

According to an aspect of the invention, the current communication mode may be communicated with its validity time.

According to an aspect of the invention, the current communication mode may be communicated with the next expected communication mode.

According to an aspect of the invention, the at least one network message may comprise an indication that the data communication mode should be immediately enabled. Said behaviour corresponds to a request to perform a “hard switching” of the data communication mode.

### BRIEF DESCRIPTION OF THE DRAWINGS

The foregoing and other purposes, features, aspects and advantages of the invention will become apparent from the following detailed description of embodiments, given by way of illustration and not limitation with reference to the accompanying drawings, in which:

FIG. 1 represents a system for tracking containers;

FIG. 2 shows a mobile device able to implement the method for data communication;

FIG. 3 illustrates an example of a data frame exchange comprising a data communication mode; and,

FIG. 4 represents a method for data communication.

### DESCRIPTION OF THE INVENTION

### System for Multi-Frequencies Radio Communication

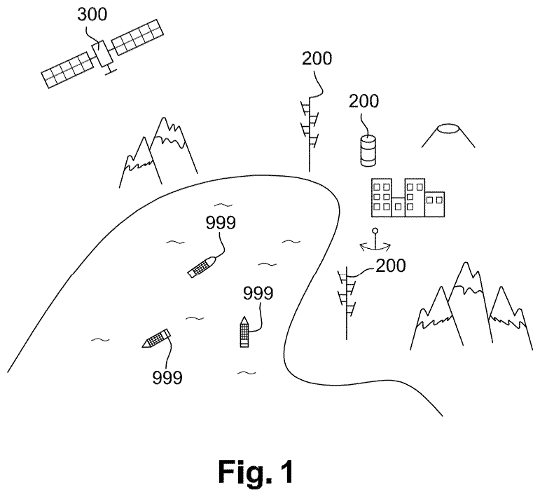

FIG. 1 illustrates a non-limiting example where autonomous energy capacity and mobile network can be optimized during position tracking. Of course, the method according to the invention could be applied to other types of mobile devices than tracking devices, like sensor communicating physical parameters.

FIG. 1 shows three container ships carrying multiple containers 999. Each container 999 comprises a mobile device 100, having a cellular mobile device system 110.

The container may be delivered by a container ship operator or another transport service. Any stakeholder involved in the transport chain (e.g., container owner or leaser, cargo owner, etc.) may wish to track a container 999 in order to determine the container 999 position and monitor its related physical parameters.

Mobile device 100 may provide relevant value for all transport chain stakeholders. The data collected by mobile device 100 may be beneficial to the cargo owner, the container owner, customs and regulatory authorities, and facilitate the onboard vessel monitoring and the ports and/or terminals management. This may increase visibility and may allow improving the logistics chain management, simplifying the Reefer monitoring on board of vessels, modernizing the terminals and increasing its efficiency, and enhancing the overall cargo transport security.

The container owner may desire to know with great accuracy when the container 999 may arrive and also whether the container underwent vibrations, the door has been opened, the atmospheric conditions are in ranges and so on.

These different values should be transmitted from the mobile device 100 to the terminal 200 via different communication technologies such as radio, cellular and satellite communication technologies. In order to have a better coverage and mutualize energy usage, radio communication is deployed as a complementary communication solution in addition to cellular and/or satellite communication technologies. In fact, radio communication enables better coverage by enabling devices that are the bottom of the deck for example and have no line of sight to communicate using different devices via multi-hoping radio communication. In addition, when cellular communication technologies are I used, the scan and attach steps to select a network are the most costly steps in terms of energy consumption. One can consider selecting a leader out of the available devices that will receive the data from its neighboring devices and send it in their behalf using different communication technology that is more energy consuming than radio communication. Hence, the energy deployed to scan and attach to a network will be consumed once instead of being consumed by all the devices within the cluster. However, it is not simple to employ radio communication for mobile devices that are deployed in harsh highly metallic environments and are frequently roaming. It is well known that frequency band to use for communication, or rather radio communication is different from a region to another.

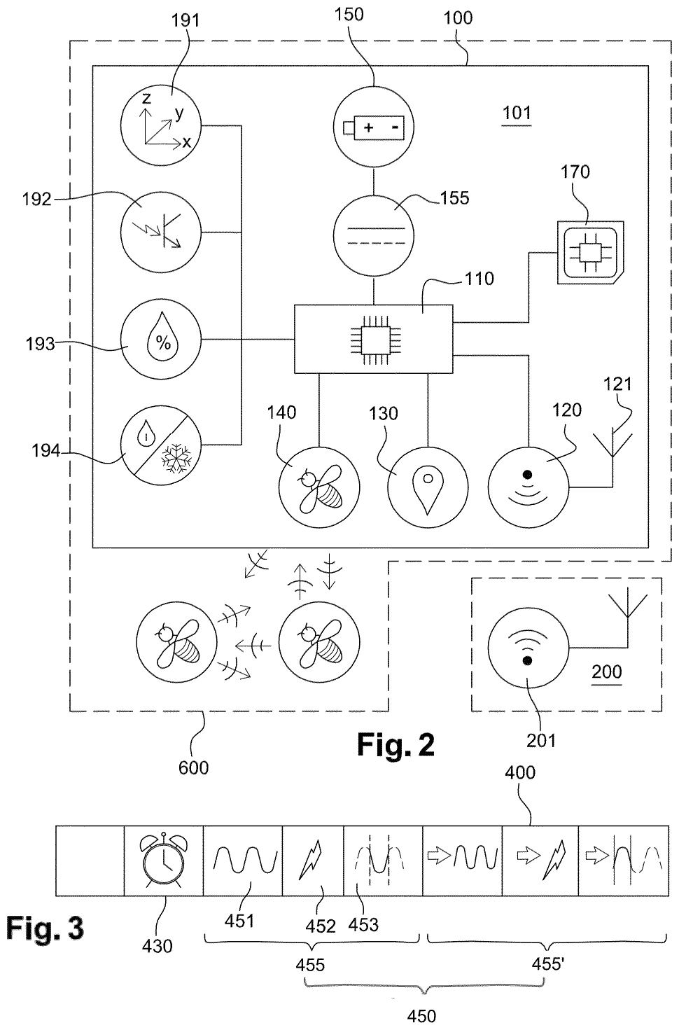

Therefore, the mobile device 100 needs a series of strategies to automatically select the most appropriate frequency band to use in the communication with other mobile devices 100. These series of strategies are operated by the mobile device system 110, which is represented in FIG. 2. The frequency band is selected according to the current geographic position of the mobile device 100 and the Short Radio Devices regulations.

The Short Range Devices, SRD for short, is a recommendation which describes radio frequency transmitter devices used in telecommunication for the transmission of information, which have low capability of causing harmful interference to other radio equipment.

In order to be able to operate worldwide, mobile devices 100 may employ different frequency bands. As today, three different frequency bands which are the 433.05-434.79 MHz band, 433 MHz for short, the 868.0-870.0 MHz band, usually abbreviated to 868 MHz, and the 902-928 MHz band, which by convention, is abbreviated to 915 MHz can be sufficient to communication worldwide.

Such frequency bands are differently regulated by national and international standards. In order to manage the global frequency allocation, International Telecommunication Union divides the world into three regions. The proposed strategy to select the most appropriate frequency band can be adapted if new frequency bands become acceptable in the future.

For instance, in a harbor of Region 1 like Marseille, the mobile device may use the 433 MHz and the 868 MHz band for communication but it is not allowed to use the 915 MHz band. The first region may have some exception for the 915 MHz band like South Africa, since the country may allow the use of the 915 MHz band for communication.

The availability of the most common frequency bands dedicated to SRD in International Telecommunication Union Regions is reported in Table 1.

TABLE 1
SRD frequency bands

| Band | Region 1 | Region 2 | Region 3 |
|---|---|---|---|
| 433 MHz | Available | Available with | Available in most |
| | | strong limitations | of the countries with |
| | | | strong limitations in |
| | | | IN, JP and KR |
| 868 MHz | Available | Not available | Available in some |
| | | | countries (RU, IN, PH) |
| 915 MHz | Available | Available | Available in most |
| | only in ZA | | of the countries |
| | | | (except IN and PH) |

### Mobile Device Architecture

FIG. 1 is a block diagram of a mobile terminal 100 which may include a mobile terminal system 101 which communicates through a wireless communication network 200. Mobile terminal system 101 may comprise an accelerometer sensor 191, a light sensor 192, a hydrometer sensor 193 and a temperature sensor 194, each of them may be coupled to a controller 110. Controller 110 may be also coupled to radio frequency transceiver circuit 120, transceiver 120 for short and an antenna 121. Typically, controller 110 may represent a central processing unit which runs operating system software in a memory component (not shown). Controller 110 may normally control the operation of mobile terminal 100 and the signal processing operations associated with communication functions may be typically performed in transceiver circuit 120. Transceiver circuit 120 interfaces with antenna 121 in order to receive or transmit information.

Mobile terminal 100 may send communication signals to and receive communication signals from mobile network 200 via antenna 121. Transceiver circuit 120 may perform functions similar to those of station terminal 200, including for example modulation/demodulation and possibly encoding/decoding and encryption/decryption.

Mobile terminal 100 may operate using at least one SIM card 170 which may be connected to or inserted in mobile terminal 100 at a SIM card interface (not shown). A SIM card 170 may be a Universal Integrated Circuit Card (UICC) loaded with one or multiple network operators' profiles. SIM card 170 may be one type of a removable identity card used to identify a mobile terminal or a container and to personalize the device, among other things. SIM card 170 may store additional user information for the mobile terminal as well, including logbook and for information.

Mobile terminal 100 may communicate in and through wireless communication network 200. Wireless communication network 200 may be a classical networkular telecommunications network. In the embodiment of FIG. 1, wireless network 200 may be configured in accordance with cellular radio network technologies of 2^{nd} to 5^{th} generation.

Mobile terminal 100 may include a communication unit 140 comprising an additional transceiver circuit and antenna to communicate on a wireless local area network and in particular with other mobile terminal of a cluster as will described below.

Mobile terminal 100 may include a satellite-based positioning system receiver 130 coupled to controller 110. The corresponding satellite-based positioning system may be Glonass, Galileo or GPS for example.

Mobile terminal 100 may include an autonomous energy capacity or one or more rechargeable or non rechargeable batteries 150. We will refer globally to this energy supply as battery 150. Battery 150 may supply electrical power to electrical circuit in mobile terminal 100. Battery 150 may be coupled to a power regulator 155 which may regulate power to the device. When mobile terminal 100 is operational, the transceiver circuit 120 may be turned on only when it may be sending to network, and may be otherwise turned off to conserve resources and in particular the autonomous energy capacity 150. Similarly, a receiver of transceiver circuit 120 may be typically periodically turned off to conserve power until it may be needed to receive signals or information.

### LAN/Cluster Description

When multiple mobile terminal 100 are present within reach of communication unit 140, a local area network is defined.

The local area network 600 comprises at least one cluster which includes a set of mobile devices 100. A head node or leader node may be defined as well as member node. The logic for defining such a cluster and head/member nodes is described in previous patent applications WO2016005675, WO2016151259 and WO2016083745.

The header node may be in better position to perform communication with a wireless communication network compared with member nodes (having more energy, a better coverage or a better signal strength). The head node will take responsibility to communicate with said wireless communication network 200 on behalf of the cluster while communicating to the member nodes through the local area network 600.

### Data Communication Mode

The mobile device may specify customizable operating modes in order to be in conformity with most of international and regional regulations. Said modes can be defined as a data communication mode 450.

A data communication mode 450 may define at least a radiofrequency band 451 for communicating data. A data communication mode 450 may also define at least a transmission power 452 information in relation with said radiofrequency band for communicating data. A data communication mode 450 may also define sub bands 453 within the radiofrequency band 451.

The data communication mode may be defined, for example, by a 1-Byte parameter which is composed by different fields as illustrated in Table 1.

TABLE 1
PHY_MODE 450 parameter format

| | | | | | | | |
|---|---|---|---|---|---|---|---|
| 7 | 6 | 5 | 4 | 3 | 2 | 1 | 0 |

| Band | Txpwr | Sub-band |
|---|---|---|
| 2 bits | 2 bits | 4 bits |

The main frequency band is selected by the first 2 bits of the data communication mode parameter. The possible values are reported in Table 2.

TABLE 2
Band values

| Value | Band | Description |
|---|---|---|
| 0 | 433 MHz | From 433.05 MHz to 434.700 MHz |
| 1 | 868 MHz | From 868 MHz to 870 MHz |
| 2 | 915 MHz | From 915 MHz to 928 MHz |
| 3 | SILENT | No frequency bands defined: |
| | | mobile device is not allowed |
| | | to transmit. |

Table 3 defines an example of possible values of transmission power that can be selected with the last 2 bits, positions 4 and 5, of the data communication mode parameter.

TABLE 3

| Value | Txpwr | |
|---|---|---|
| 0 | 13 | dBm |
| 1 | 10 | dBm |
| 2 | 0 | dBm |
| 3 | −10 | dBm |

The sub-frequency-band is defined by 4 bits, positions 0 to 3, of the data communication mode parameter. Thus, mobile device can define up to 16 sub-bands for each main band. The different sub-bands are illustrated below.

The data communication mode allows customizing the physical layer of mobile device by selecting the frequency band and the maximum permitted transmission power. Thus, a set of operating modes can be defined to comply with the international and regional regulations in force in the worldwide. Table 4 provides some examples.

TABLE 4

| | Band | Txpwr | Sub-band | PHY_MODE |
|---|---|---|---|---|
| Mode | 451 | 452 | 453 | 450 |
| ETSI 868 MHz | 1 | 0 | 0 | 0x40 |
| | | | | 01\|00\|0000 |
| FCC 915 MHz | 2 | 0 | 0 | 0x80 |
| | | | | 10\|0000\|00 |
| ARIB 915 MHz | 2 | 0 | 1 | 0x81 |
| | | | | 10\|00\|0001 |
| Korea 917 MHz | 2 | 2 | 3 | 0xA3 |
| | | | | 10\|10\|0011 |
| ETSI 433 MHz | 0 | 1 | 0 | 0x10 |
| | | | | 00\|01\|0000 |

Mobile devices 100 transiting from a region to another should be able to automatically switch to the proper frequency band 451 in compliance with the local SRD regulations.

The data communication mode 450 is associated with a validity time period 430. For example, the validity time period may be expressed in periods of 30 minutes for example. If the current time 410 exceed the validity period 430, the data communication mode 450 is not valid anymore. In such case, the obtained data communication mode 450 is considered unreliable.

### Method for Data Communication of a Mobile Device

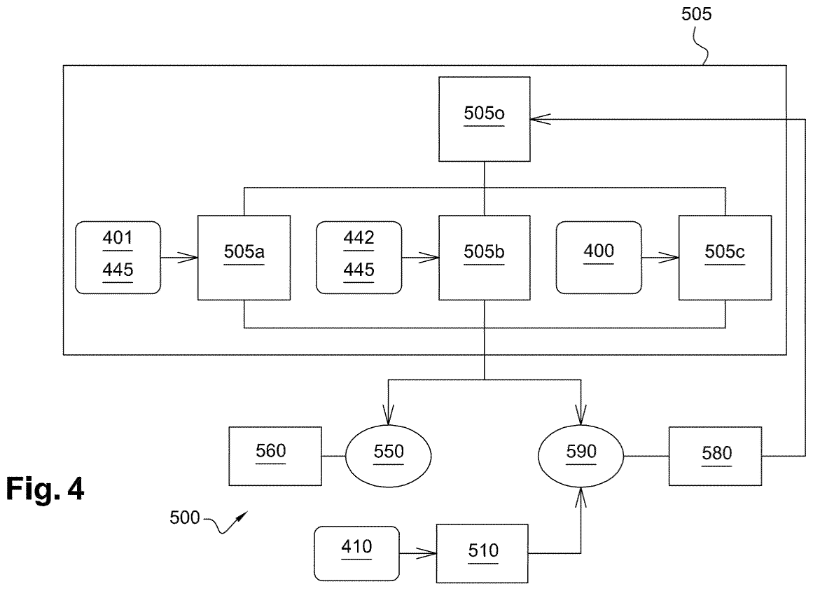

FIG. 4 illustrates a method for data communication 500 operated by the mobile device communication system 110 of mobile device 100.

The method 500 comprises a step of determining 505 a data communication mode 450.

The determination 505 of said data communication mode is initiated in sub-step 505o and may be performed according to different possibilities.

According to a first possibility corresponding to sub-step 505a, the data communication mode is determined based on a piece of geographical localization information 441 obtained from a mobile communication network 200. The piece of geographical localization information obtained from a mobile communication network 200 may be a mobile country code 441. Therefore, the sub-step 505a is performed using a repository 445 defining values of data communication modes 450 corresponding to geographical areas. The repository 445 may have the form of a table for example. This repository 445 may be stored in the host mobile device may be used in this case to identify the Country corresponding to the piece of geographical localization information or the mobile country code 441 obtained, for example, from the GSM network. The geographical area may be determined by converting the piece of geographical localization information obtained from the mobile communication network or the satellite-based positioning system. This repository 445 might be updated by a remote server. The definition of some macro regions such as Europe can be applied to reduce the overall size of this table.

According to a second possibility corresponding to sub-step 505b, the data communication mode is determined based on a piece of geographical localization information 442 obtained from a satellite-based positioning system 130. In such case the repository 445 may be also built with geographical localization information obtained the satellite-based positioning system 442. As the geographical localization information may be redundant, the method 500 may comprise a step of compression in order to reduce or suppress the redundant piece of geographical localization information. The repository 445 may be then compressed by applying a definition of some macro-regions, such as Europe, or by using a Run-length encoding in order to suppress redundant piece of information.

According to a third possibility corresponding to sub-step 505c, the data communication mode is determined based a data communication mode 450 obtained from the data frame exchange 400 on said local area network as shown on FIG. 3. The mobile device 100 may try to retrieve a data communication mode 450 defined by other nodes in the local area network 600. The mobile device communication system 110 of a mobile device 100 can obtain the network data communication mode 455 by reading the network data communication mode 455 in different manners. The host mobile device is in charge to keep up-to-date said data communication mode 450.

If the determination step is successful the data communication state 550 of the mobile device 100 is enabled. In this data communication state, a radiofrequency band 451 defined on the basis of said data communication mode 450 for data communication between the mobile device 100 and the local area network 600 is allowed. Otherwise, if the determination step failed such that no valid data communication mode can be determined, the mobile device 100 enters a silent state 590. However, the mobile device 100 is allowed to listen to special channels dedicated to the broadcast of the data communication mode 450 in the network, i.e. it enters a sniffer mode 580.

If the determination step is successful, the mobile device 100 may also communicate the data communication mode 450 to other mobile devices 100 in the local area network in a step 560.

The method 500 also comprises a step 510 of verifying the validity of the data communication mode 450 based on a current time 410 and the validity period 430. If the current time 410 exceed the validity period 430, the data communication mode 450 is not valid anymore. In such case, the mobile device 100, or the host mobile device of the local area network 600 sets the data communication mode 450 to “SILENT” such as to enter the silent state 590. Consequently, the radio module enters the silent state 590 in which it is not allowed to transmit. The device also enters a sniffer mode 580.

The validity time 430 can be computed by the host mobile device 100 of the local area network 600 that is typically a mobile device 100 having a mobile communication network connection 120, like GSM, or the capability of acquiring its satellite-based position 130 by satellite-based positioning system like GPS, Galileo and Glonass for example. The host mobile device can set the validity time 430 to a value comprised between 1 and 6.5 hours, for instance, and should compute the probability that the local area network 600 passes from a country to another and taking account of the type of node.

If a new data communication mode 450 is expected at the end of the validity time 430, the intended mobile device 100 enters a silent state 590 and the sniffer mode 580. Indeed, when the validity time 430 of the current data communication mode 450 expires, the mobile device 100 tries to retrieve a new data communication mode 450 either using the GSM connection, the LAN connection or the GPS position as mentioned before.

### Sniffer Mode

To recover silent nodes, a secondary beacon channel, for example, may have been defined in the two bands 868 MHz and 915 MHz on the frequencies reported in Table 5.

TABLE 5
Sniffer frequencies

| Band | Center frequency | |
|---|---|---|
| 868 MHz | 866.05 | MHz |
| 915 MHz | 922.615 | MHz |
| 433 MHz | 433.92 | MHz |

Such frequencies have been selected by identifying the portions of frequency bands 451 most commonly permitted by international and regional SRD regulations. Every 15 minutes, each Mobile device having a valid data communication mode 450 transmits a message on a channel of the current band using the maximum permitted transmission power 452. The message contains the current position 440 of the source, the current network data communication mode 455, the validity time 430 and the next data communication mode 455′.

The sniffer node 580 permanently listens to the defined network data communication mode 455 channels trying to intercept a network data communication mode 455 message broadcast by its neighbors. The sniffer frequencies are cycled with a period of 20 minutes, for example, which ensures to intercept a network data communication mode 455 message when only a neighbor is in the communication range. In the worst case, a non-isolated sniffer node 580 receives a network data communication mode 455 message after 1 hour, for example.

The first network data communication mode 455 channel scanned by the sniffer mode 580 is that indicated by the last network data communication mode 455 stored in memory. A mobile device 100 is allowed to transmit network data communication mode 455 messages only if its validity time 430 is greater than half an hour, for example. This restriction prevents the formation of possible loops in which two mobile devices update each other with an inconsistent validity time 430, for example.

### Head and Member Nodes Strategy

The strategy adopted by mobile device mainly depends on their status in the network. Some mobile devices, which have access to other computers on the local area network 600, are called head nodes or host node. The head nodes have GSM connection and use the piece of geographical localization information, like mobile country code 441 for example, to compute the current data communication mode 450. As a result, they become the network data communication mode 455 sources and are in charge of broadcasting the current data communication mode 450 in HANN messages in step 560. If the head node is capable to acquire the piece of geographical localization information by GPS, then it becomes a geographical localization information source as well.

A normal mobile device, also called member nodes, use the network data communication mode 455 unless they have a valid piece of geographical localization information. In the latter case, they use it until its expiration and then use the network data communication mode 455 and the piece of geographical localization information contained in the received HANN messages without trying to acquire a new piece of geographical localization information by GPS. However, if the hosting head node is not a geographical localization information source then the members can attempt to acquire the piece of geographical localization information by themselves.

Similar to members, there is affiliate nodes. The affiliate nodes use the network data communication mode 455 unless they have a valid piece of geographical localization information. In the latter case, they use it until its expiration and then use the network data communication mode 455 and the piece of geographical localization information contained in the received REP messages without trying to acquire a new piece of geographical localization information by GPS. However, if the hosting member has an undefined piece of geographical localization information, like zeros or a blank position, affiliates can attempt to acquire the piece of geographical localization information by themselves.

In some case, the mobile device may be defined as loose node. The loose nodes use the network data communication mode 455 unless they have a valid piece of geographical localization information. In the latter case, they use it until its expiration and then attempt to acquire a new piece of geographical localization information. If they fail, then enter in sniffer mode and try to acquire a valid network data communication mode 455.

When a change of data communication mode 450 is expected, because of the transition from a region to another for example, all network nodes involved in this transition should switch to the proper data communication mode 450 at the right moment without invading forbidden frequencies. For this reason, a node cannot directly switch to the next data communication mode 455′ at the expiration of the validity time 430. Actually, the only way to be sure that the new data communication mode 450 is presently in force in the current geographical localization 440 is through the acquisition of a new data communication mode 450. Hence, the method 500 comprises a step of communicating to at least one node a next data communication mode 450.

As explained in the previous paragraphs head nodes acquire it by mobile communication network and non-head nodes by the reception of a network data communication mode 455 message while in sniffer mode 580. As a result, the transition from a region to another causes an interruption of the normal network operations in nodes (transition blackout) which may last until 1 hour. Therefore, the piece of geographical localization information comprises the next geographical localization information and this next geographical localization information is obtained by extrapolation of the geographical localization.

In some cases it may be possible to switch to the next data communication mode 450 before entering in a new region in order to prevent the transition blackout. Below we present two possible scenarios in which this approach can be applied.

One of these scenarios may be when a container ship is transiting from international waters to national waters. Since no specific regulations are defined in international waters, it would be possible to switch to the next data communication mode 450 before entering in the approaching national waters.

The other scenario may be when regional regulations are less stringent in proximity of the borders. In these cases, mobile devices may switch to the next data communication mode 450 before entering in the new region. If a head node expects to enter in a new region in less than half an hour and if one of the above mentioned cases are identified, then the hard switching can be applied. The hard switching consists of broadcasting a new HANN indicating the next data communication mode 450 as the one currently in use. All members receiving such a HANN message will then directly switch to the indicated data communication mode 450 without entering in sniffer mode 580 or silent state 590.

However, for affiliate nodes the hard switching is not applicable. The steps involved in this procedure are the following:

1. The host device in the head node updates the data communication mode 450;

2. The host device in the head node commands the sending of a HANN message;

3. The host device in the head node switches to the new data communication mode 450.

### Remote Sensors

Remote sensors have neither mobile communication network module nor satellite-based positioning module. Thus the only ways to obtain the network data communication mode 455 and update its validity time 430 is either to receive a Sub-Sensor Network Update message from the parent mobile device or receive a network data communication mode 455 message in sniffer mode 590.

Thus, a remote sensor behaves like a mobile device without mobile communication network module nor satellite-based positioning module: it becomes silent when it has not information about the data communication mode 450 presently in force and it enters in sniffer mode and cycles the network data communication mode 455 frequencies in order to intercept a network data communication mode 455 message.

In case of Hard switching, a mobile device updates the data communication mode 450 in the sensors of its Sub-Sensor Network before switching to the new data communication mode 450. To do so, a Sub-Sensor Network Update is transmitted with the new data communication mode 450 and all sensors receiving it switches immediately to the indicated data communication mode 450 without entering in sniffer mode. In this way, the Hard Switching is applied also to the Sub-Sensor Network of the involved mobile devices. The Sub-Sensor Network Update is a message broadcast by the parent mobile device every hour using the dedicated Sub-Sensor Network beacon channel to keep up-to-date the data communication mode 450 and the timestamp in the attached sensors.

1) A method for data communication of a mobile device on a local area network, having a mobile device communication system, on an authorized radiofrequency band; the method comprising the following steps:
determining a current data communication mode, said current data communication mode defining at least a radiofrequency band for communicating data; said determination of said data communication mode being performed using:
a) a piece of geographical localization information obtained from a mobile communication network or a satellite-based positioning system; or
b) a data communication mode obtained from a data frame exchange on said local area network;
if the determination step is successful:
enabling a data communication state of the mobile device wherein use of a radiofrequency band defined on the basis of said current data communication mode for data communication between the mobile device and the local area network is allowed; or,
if the determination step is not successful such that no valid data communication mode can be determined:
entering a silent state; and
entering a sniffer mode.

2) The method according to claim 1, wherein the current data communication mode is associated with a validity time period and the method comprises a step of verifying a validity of the current data communication mode based on a current time and the validity period, and entering a silent state and or a determination step if the result of the verification step is not successful.

3) The method according to claim 2, comprising a step of receiving the validity time period for the current data communication mode in network messages from a current leader node of the local area network.

4) The method according to claim 2, comprising a step of updating the validity time of the current data communication mode according to the information transmitted by a current leader node in the local area network.

5) The method according to claim 1, comprising a step of immediately enabling a new data communication mode (455) communicated by a current leader node of the local area network.

6) The method according to claim 1, wherein the sniffer mode corresponds to a step of listening to at least one dedicated channel for the reception of at least one network message comprising a current network data communication mode (455) and/or a next communication mode (455′).

7) The method according to claim 6, comprising a step of receiving at least one dedicated network message comprising a current network data communication mode and/or a next communication mode.

8) The method according to claim 6, wherein the at least one message comprises a validity time period associated with the current network communication mode.

9) The method according to claim 1, wherein the step of determination of said data communication mode being performed using a piece of geographical localization information is performed using a repository defining values of data communication modes corresponding to geographical areas.

10) The method according to claim 1, comprising a step of communicating (560) to at least one node on the local area network a current network or next data communication mode in at least one network message.

11) The method according to claim 2, comprising a step of immediately enabling a new data communication mode communicated by a current leader node of the local area network.

12) The method according to claim 3, comprising a step of immediately enabling a new data communication mode communicated by a current leader node of the local area network.

13) The method according to claim 4, comprising a step of immediately enabling a new data communication mode communicated by a current leader node of the local area network.

14) The method according to claim 12, wherein the sniffer mode corresponds to a step of listening to at least one dedicated channel for the reception of at least one network message comprising a current network data communication mode and/or a next communication mode.

15) The method according to claim 13, wherein the sniffer mode corresponds to a step of listening to at least one dedicated channel for the reception of at least one network message comprising a current network data communication mode and/or a next communication mode.

16) The method according to claim 14, comprising a step of receiving at least one dedicated network message comprising a current network data communication mode and/or a next communication mode.

17) The method according to claim 15, comprising a step of receiving at least one dedicated network message comprising a current network data communication mode and/or a next communication mode.

18) The method according to claim 7, wherein the at least one message comprises a validity time period associated with the current network communication mode.

19) The method according to claim 18, wherein the step of determination of said data communication mode being performed using a piece of geographical localization information is performed using a repository defining values of data communication modes corresponding to geographical areas.

20) The method according to claim 18, comprising a step of communicating to at least one node on the local area network a current network or next data communication mode in at least one network message.
